(19) United States
(12) Patent Application Publication
(10) Pub. No.: US 2002/0162052 A1
(43) Pub. Date: Oct. 31, 2002

(54) Method for entering system firmware recovery mode using software-detectable buttons

(76) Inventor: Timothy A. Lewis, El Dorado Hills, CA (US)

Correspondence Address: Claudia Cameron, Phoenix Technologies Ltd., 411 East Plumeria Drive, San Jose, CA, 95134, US

(21) Appl. No.: 09/841,864

(22) Filed: Apr. 25, 2001

(51) Int. Cl. G06F 11/00

(52) U.S. Cl. 714/36

(57) ABSTRACT

Methods that detect a user's desire to enter a firmware recovery mode using one or more software-detectable buttons, such as power and/or sleep buttons, such as those on the front panel or keyboard of a computer system. An exemplary firmware recovery method comprises the steps of detecting the status of the one or more software-detectable buttons at power-on, distinguishing between the normal use of the selected button(s) and as a recovery button(s), and initiating firmware recovery. Upon initial power-on, system firmware detects the one or more software-detectable buttons held down for a predetermined time period, or that are sequentially held down, after which the one or more software-detectable buttons are released. The depressing and releasing action of the selected button(s) is used as an indicator to initiate the recovery mode. The present invention thus uses traditional buttons to initiate firmware recovery mode.

### BACKGROUND

The present invention relates generally to computer systems and methods, and more particularly, to methods for entering system firmware recovery mode using software-detectable buttons, such as power and/or sleep buttons.

Computer systems often fail to operate correctly upon power-on. Many times this is because the firmware needs to be updated or because a system setting has been corrupted or is incorrectly set. These failures sometimes result in a scenario where the computer system cannot operate even to the point of allowing the user to correct the situation.

In the basic input/out system (BIOS), this problem is solved using a portion of code known as a “boot block.” The boot block is a known-good portion of code that is not updated during a BIOS update and whose sole purpose is to restore the system firmware image and system settings. Currently, there are several schemes used to detect the desire to restore the system firmware image.

One scheme is to check the BIOS checksum to see if it is valid. Another scheme is to check the status of a particular motherboard jumper. Another scheme is to check for a special “dongle” attached to an external port (such as serial or parallel). Another scheme is to check for a special key press. Another scheme is to attempt to connect to an external system via a serial (or other) port to check for a download. Another scheme is to check for or use a special plug-in card.

These methods take advantage of simple interfaces, such as a jumper, a PC keyboard, or a serial or parallel port. Some methods also require access to the motherboard or slots. However, some systems do not have these devices or else use “sealed boxes” that do not allow access to slots or jumpers.

Three methods for detecting a need for recovery are described in an Intel Application Note AP-636, entitled “Preventing BIOS Failures Using Intel Boot Block Flash Memory,” page 6. Here it describes checking for a checksum failure, a special motherboard jumper or a special plug-in card. Another method (using a key press) is known to the inventor to have been used in versions of the Award BIOS, circa 1995. Another method (connecting to an external system) is known to have been used in Lucent firmware in 1995. Furthermore, there is a special “dongle” approach described in the Phoenix Developer's Reference for Phoenix BIOS 4.0, Release 6.0, at page 279.

In general, disadvantages of the prior art are as follows. A checksum failure is a valid means of detecting the need for recovery. However, it doesn't address cases where the BIOS checksum is valid but the code is wrong (i.e., causes a hang). Checking for a motherboard jumper or installing a special board or component in a slot requires access to the motherboard. However, some systems (i.e., “sealed box”) do not give the user access to internal components or slots.

Checking for a key press using a standard PC keyboard cannot be used on some systems because they do not offer a standard PC port. Also, some keyboard controller architectures in some super I/O components cannot detect key presses before the BIOS has been copied to RAM. Checking for a key press on USB keyboards requires a sizeable body of code to support it and also a good deal of time to enumerate a crowded bus.

Checking for a remote system using a port requires that a port be present on the system. However, for cost reasons, some systems do not have a port. Also, it requires special hardware and possibly a second system in order to flash the BIOS. Checking a dongle requires that an external port be present and that the user have access to such a specially constructed device. However, some systems may not have the external port and users may not have access to the port.

A computer search was performed on the present invention that resulted in several patents that somewhat relate to the present invention. These patents include U.S. Pat. No. 6,018,806, U.S. Pat. No. 5,805,882, and U.S. Pat. No. 5,398,333.

U.S. Pat. No. 6,018,806 entitled “Method and System for Rebooting a Computer Having Corrupted Memory Using an External Jumper” discloses that a “computer system includes a flash memory device for storing BIOS code. The BIOS code is stored in an unprotected area of the flash memory. A boot block, stored in a protected area of the flash memory, is used for rebooting the computer system in the event that the flash memory device becomes corrupted. During normal operation, the BIOS code is updated using a radio link. If the BIOS is corrupted while being updated, a recovery routine stored in the boot block is executed. The recovery routine permits the corrupted BIOS to be reprogrammed using a serial interface instead of the radio link.”

It is stated in U.S. Pat. No. 6,018,806 that “an external jumper (not shown) is inserted into the header 1100 to shunt the test mode signal TEST.sub.—MODE to system ground to enable the system to execute code from the protected or boot block area of the flash memory device 742 in order to enable the system to be booted. Once the system is booted, the flash memory device 742 is reprogrammed by way of the serial interface 894 (FIG. 29). Once reprogramming is complete, the shunt is removed from the header 1100 (FIG. 30) and the adapter plug 790 is removed, restoring the system to normal operation.” It is recited in claim 6 that the system includes “means for enabling said computer system to be booted during a condition when said non-protected area of said memory is corrupted including one or more terminals adapted to receiving an external jumper which, when installed, causes said computer system to execute disaster recovery BIOS code from said protected area in said memory in order to enable said computer system to be booted in the event that said memory is corrupted and to enable said flash memory devices to be updated by way of said communications interface.

U.S. Pat. No. 5,805,882 entitled “Computer system and method for replacing obsolete or corrupt code contained within reprogrammable memory with a new boot code supplied from an external source through a data port” states that it replaces obsolete or corrupt code by using an external source via a data port. It is stated in U.S. Pat. No. 5,805,882 that “a computer system is provided with a flash read-only-memory (ROM), a microcontroller and a data port. The microcontroller initially owns the flash ROM. The microcontroller further has a separate ROM upon which it can execute boot-up instructions. After booting up, the microcontroller checks the flash ROM contents, preferably by performing a check-sum of the flash ROM contents. If the checksum of the flash ROM contents matches an expected value, the microcontroller releases ownership of the flash ROM to the computer system so that the computer system boots-up as normal. If the microcontroller determines that the flash ROM has become corrupted, the microcontroller accesses the data port and looks for a flash programming protocol. If the protocol is present at the data port, the microcontroller receives the data from the data port and programs the flash ROM accordingly. In this manner, the flash ROM can be updated to a good known state, even if the computer system is not able to boot up due to, among other things, the corruption of the flash ROM.” Thus, the microcontroller uses the data port to update the flash ROM in the event the computer system is not able to boot up due to corruption.

U.S. Pat. No. 5,398,333 entitled “Personal computer employing reset button to enter ROM based diagnostics” states that it discloses “a system and method for providing user-invocable, non disk-based diagnostics routines for a personal computer. The method comprises the steps of (1) storing a diagnostics routine capable of performing diagnostic tests on portions of the personal computer in ROM, (2) monitoring a status of a reset button coupled to the personal computer and (3) executing the diagnostics routine if the reset button is pressed twice within a preselected period of time. The disclosed system and method allow a user to control the invocation of a diagnostics routine that needs a minimum of functioning computer hardware to execute.” While U.S. Pat. No. 5,398,333 discloses the use of a reset button to enter ROM based diagnostics, not all computers necessarily have a reset button.

It would be desirable to have methods that overcomes limitations of the prior art, and in particular the patents mentioned above. It is an therefore objective of the present invention to provide for methods for entering system firmware recovery mode using software-detectable buttons, such as power and/or sleep buttons.

### SUMMARY OF THE INVENTION

To accomplish the above and other objectives, the present invention provides for methods that detect a user's desire to enter firmware recovery mode using software-detectable buttons. Exemplary software-detectable buttons include power and/or sleep buttons on the front panel or keyboard of a computer system. In newer systems, the power and/or sleep buttons are accessible and are detectable by software.

In accordance with the present invention, upon initial power-on, the system firmware detects the one or more software-detectable buttons, such as the power and/or sleep buttons, held down for a predetermined time period or that are sequentially held down, after which the buttons are released. The depressing and releasing action of the selected button(s) is used as an indicator to initiate the recovery mode. The present invention thus uses traditional power buttons (or their equivalent on some keyboards)to initiate firmware recovery mode.

In particular, an exemplary embodiment of the present invention is a firmware recovery method that comprises the steps of (a) detecting the status of software-detectable button(s), such as the power and/or sleep button(s) at power-on, (b) distinguishing between the use of the selected button(s) as a power and/or sleep (or other predetermined use) button and as a recovery button, and (c) initiating firmware recovery subsequent to release of the button(s).

With regard to (a), at power-on the status of the power and/or sleep button(s) are detectable when they are pressed and released. For instance, on most chipsets supporting the Advanced Configuration and Power Interface, this is supported through a PM1a_CNT register, but on others it is detectable by reading another device register. For example, on an Intel ICH device, a PWR-LVL register is used instead.

With regard to (b), since the power and/or sleep buttons (or other selected buttons) have other uses, it must be possible to distinguish between their normal use and their use as a “recovery” button. In the case of the sleep button, for example, there is little difficulty since the sleep button is not normally depressed upon power-on. In the case of the power button, it may be depressed upon power-on simply because the user has failed to release it. In addition, on some systems, holding the power button for an extended period of time may be a way to force the system off.

Therefore, in order to distinguish between a “recovery” button and a malfunctioning button, one of the methods described below may be used. (1) Both the power and the sleep button must be held down at power-on. (2) Either one or the other button may be held down for a predetermined time period, at which point there is an indication to the user (beep, flashing signal or light) that indicates the user should let go. A platform-specific button may be used instead of or in combination with the above buttons.

With regard to (c), once the “recovery” function has been detected, recovery is initiated either by attempting to reprogram the flash memory by way of a floppy disk (or other nonvolatile memory device) or an input/output port, or by resetting system configuration variables, or both.

### BRIEF DESCRIPTION OF THE DRAWINGS

The various features and advantages of the present invention may be more readily understood with reference to the following detailed description taken in conjunction with the accompanying drawing, wherein like reference numerals designate like structural elements, and in which:

FIG. 1 is a block diagram that illustrates an exemplary computer system in which the present invention may be employed; and

FIG. 2 is a flow diagram that illustrates steps of an exemplary firmware recovery method in accordance with the principles of the present invention.

### DETAILED DESCRIPTION

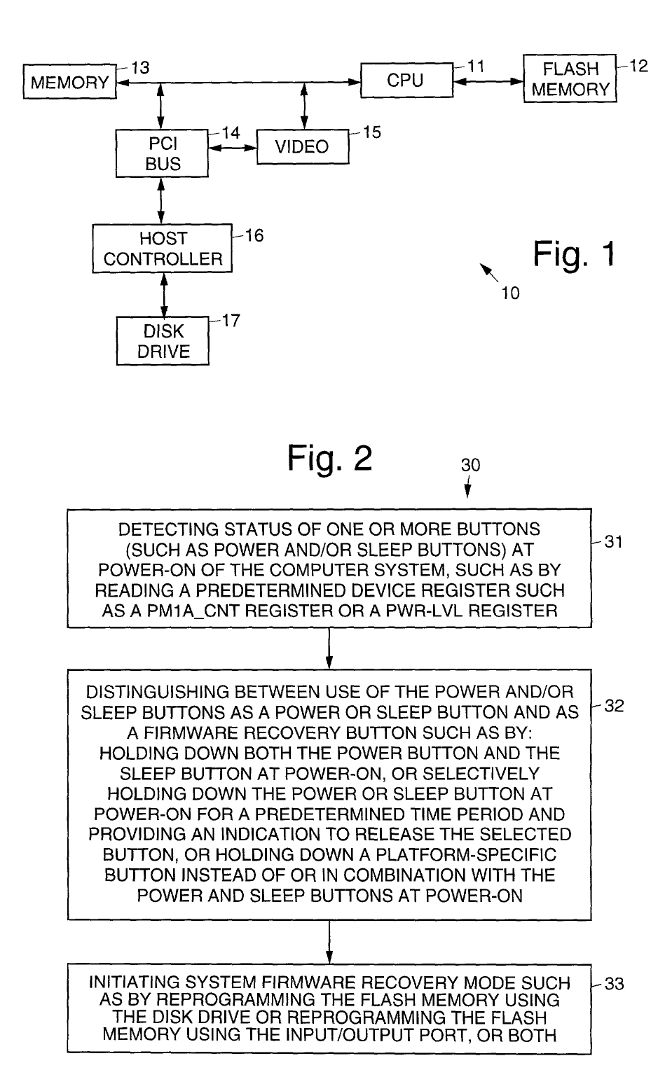

Referring to the drawing figures, FIG. 1 is a block diagram that illustrates an exemplary computer system 10 in which the present invention may be employed. The exemplary computer system 10 comprises a central processing unit (CPU) 11 that is coupled to a critical nonvolatile storage device 12. The critical nonvolatile storage device 12 may be flash memory, a programmable read only memory (PROM), an erasable programmable read only memory (EPROM), an electrically erasable programmable read only memory (EEPROM), or other device or technology that the CPU 11 can use to execute an initial set of instructions.

The CPU 11 is also coupled to a system memory 13, such as a random access memory 13. The CPU 11 may be coupled to a secondary nonvolatile storage device 17 by way of a system bus 14, such as a Peripheral Component Interconnect (PCI) bus 14, for example and a host controller 16. The secondary nonvolatile storage device 17 may be a hard disk drive, a compact disk (CD) drive, a digital video disk (DVD) drive, a floppy disk drive, a Zip drive, a SuperDisk drive, a Magneto-Optical disk drive, a Jazz drive, a high density floppy disk (HiFD) drive, or other device or technology capable of preserving data in the event of a power-off condition. A video controller 15 is coupled to the CPU 11 and system bus 14 and is operative

A first portion of the critical nonvolatile storage device 12 stores initialization code that is operative to initialize the CPU 11 and the system memory 13. A second portion of the critical nonvolatile storage device 12 stores a dispatch manager that contains a list of tasks, which must execute to initialize the computer system 10. The dispatch manager is operative to selectively load and iteratively execute a number of tasks relating to complete initialization of the computer system 10.

In operation, when the computer 10 is turned on, the initialization code is run to initialize the CPU 11 and the system memory 13. The dispatch manager is then loaded into the system memory 13. The dispatch manager executes the list of tasks contained therein to cause all required firmware (BIOS modules) to be loaded into the system memory 13 and must be executed.

The dispatch manager determines whether each required BIOS module in the system memory 13, and if it is not, finds, loads and executes each required BIOS module. The BIOS modules are typically located in the critical nonvolatile storage device 12 (flash memory) or in any of the nonvolatile storage devices 17 identified above.

If the computer system 10 fails to operate correctly when powered up, this may be because the firmware needs to be updated or because a system setting has been corrupted or is incorrectly set. These failures sometimes result in a scenario where the computer system 10 cannot operate even to the point of allowing the user to correct the situation. The present invention provides for a unique solution to this problem which will be discussed with reference to FIG. 2.

FIG. 2 is a flow diagram that illustrates steps of an exemplary firmware recovery method 30 in accordance with the principles of the present invention. In general the firmware recovery method 30 comprises the steps of (a) detecting 31 the status of the a one or more software-detectable buttons, such as power and/or sleep buttons, for example, at power-on, (b) distinguishing 32 between use of the software-detectable button(s) as having its normal use, such as the power or sleep button, for example, and as a recovery button, and (c) initiating 33 recovery of the system firmware.

With regard to (a), the status detecting step 31, at power-on the status of the power and/or sleep button (or other software-detectable button) must be detectable as pressed or released. On most chipsets supporting the Advanced Configuration and Power Interface, this is supported through the PM1a_CNT register, but on others it is detectable through reading some other device register. For example, on the Intel ICH device, another register PWR-LVL is used instead.

With regard to (b), the distinguishing step 32, since the power and/or sleep buttons, or other software-detectable button, may have other uses, it must be possible to distinguish between their normal use and their use as a “recovery” button. In the case of the sleep button, for example it is not normally not depressed upon power-on and is therefore readily distinguishable. In the case of the power button, it may be depressed upon power-on because the user has failed to release it, or on some systems, holding the power button for an extended period of time may force the system off.

Therefore, in order to distinguish between a “recovery” button and a malfunctioning button, one of the methods described below may be used in the case of the power and sleep buttons. (1) Both the power and the sleep buttons are held down at power-on. (2) Either one or the other button may be held down for a predetermined time period, at which point there is an indication to the user (beep, flashing lights or icon) that indicates the user should release the button. A platform-specific button may be used instead of or in combination with the power and sleep buttons.

With regard to (c), the recovery initiating step 33, once the recovery function has been detected, recovery is initiated either by attempting to reprogram the flash memory 12 by way of a floppy disk or an input/output port, or by resetting system configuration variables, or both.

A preferred embodiment of the present invention uses the power button. Holding it for three seconds, for example, generates a beep, and then releasing the power button provides an indication to the firmware to initiate recovery. This method works with current chipset configurations, is unlikely to be triggered accidentally, and can distinguish between recovery and a stuck button.

Other embodiments of the present invention may include a plurality of buttons that are held down simultaneously or that are sequentially held down in a predetermined sequence. These buttons and/or the sequence must each be detectable. Such is the case when using the sleep and power button together. Other preferred embodiments of the present invention may use a button other than the power button (such as the sleep button or platform specific button).

Thus, the present invention takes advantage of a user-accessible option that is present on almost all new computers. It requires no additional hardware cost to implement. It is unlikely to be triggered accidentally, and it is easily detectable.

Thus, methods for entering system firmware recovery mode using a power and/or sleep button have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A method for entering system firmware recovery mode for use with a computer system computer system having one or more buttons and a flash memory, the method comprising the steps of:
detecting status of one or more software-detectable buttons at power-on of the computer system;
distinguishing between normal use of the one or more software-detectable buttons and as firmware recovery buttons; and
initiating system firmware recovery mode.

2. The method recited in claim 1 wherein the one or more software-detectable buttons comprise power and/or sleep buttons.

3. The method recited in claim 1 wherein the detecting step comprises reading a predetermined device register.

4. The method recited in claim 3 wherein the predetermined device register comprises a PM1a_CNT register.

5. The method recited in claim 3 wherein the predetermined device register comprises a PWR-LVL register.

6. The method recited in claim 2 wherein the distinguishing step comprises holding down both the power button and the sleep button at power-on.

7. The method recited in claim 2 wherein the distinguishing step comprises:
selectively holding down the power or sleep button at power-on for a predetermined time period; and
providing an indication to release the selected button.

8. The method recited in claim 1 wherein the distinguishing step comprises holding down a platform-specific button instead of or in combination with power and sleep buttons at power-on.

9. The method recited in claim 1 wherein the computer system further comprises a disk drive and wherein the initiating step comprises reprogramming the flash memory using the disk drive.

10. The method recited in claim 1 wherein the computer system further comprises an input/output port and wherein the initiating step comprises reprogramming the flash memory using the input/output port.

11. The method recited in claim 1 wherein the computer system further comprises a disk drive and an input/output port and wherein the initiating step comprises reprogramming the flash memory using both the a disk drive and the input/output port.

12. The method recited in claim 1 wherein the distinguishing step comprises simultaneously holding down the one or more software-detectable buttons.

13. The method recited in claim 1 wherein the distinguishing step comprises holding down the one or more software-detectable buttons in a predetermined sequence.
